(19) United States
(12) Patent Application Publication
(10) Pub. No.: US 2021/0019903 A1
(43) Pub. Date: Jan. 21, 2021

(54) SYSTEM AND METHOD FOR DETERMINING AN ATTRIBUTE OF A PLANT

(71) Applicant: A.A.A. TARANIS VISUAL LTD, Tel Aviv (IL)

(72) Inventors: Amihay Gornik, Mishmar Hashiva (IL); Eli Bukchin, Ramat Gan (IL)

(73) Assignee: A.A.A. TARANIS VISUAL LTD, Tel Aviv (IL)

(21) Appl. No.: 16/512,427

(22) Filed: Jul. 16, 2019

(51) Int. Cl. G06T 7/60; G06T 7/55; G06K 9/00

(52) U.S. Cl. CPC G06T 7/60; G06T 7/55; G06K 9/00657; G01C 3/00; G06T 2200/04; G06T 2207/10032; G06T 2207/30188

(57) ABSTRACT

A system and method for determining an attribute of a plant may include obtaining, by a camera, an image of a region; producing, by a rangefinder, a measurement of a distance from the rangefinder to a plant in the region; and determining the height of the plant by correlating data in the image with the measurement.

### FIELD OF THE INVENTION

The present invention relates generally to determining an attribute of a plant. More specifically, the present invention relates to using mobile camera and rangefinder to determine attributes of plants.

### BACKGROUND OF THE INVENTION

Rangefinders are devices that measure the distance from an observer (or from a unit, e.g., from a rangefinder) to an object or a target and are known in the art. Current plant attributes measurement solutions use a rangefinder and attempt to determine attributes of a plant based on its distance from the rangefinder.

One of the drawbacks of known systems and methods is that they lack the ability to accurately determine whether a distance measured is to a plant, ground surface or other object. Accordingly, known systems and methods cannot accurately measure attributes of plants, e.g., height.

### SUMMARY OF THE INVENTION

An embodiment for determining an attribute of a plant may include obtaining, by a camera, an image of an area or region; producing, by a rangefinder, a measurement of a distance from the rangefinder to a plant in the region; and determining the height of the plant by adjusting the measurement based on correlating data in the image with the measurement. The camera and rangefinder may be mobile and may be translated over the region.

Ground surface in the region may be identified based on the image. Ground surface in the region may be identified based on a reflection of an electromagnetic wave. An embodiment may create a three dimensional (3D) image of the region based on a set of images obtained by the camera and based on a respective set of measurements. An embodiment may include directing a camera at a mirror such that its focal point is kept constant and adjusting an orientation of the mirror according to an orientation of a rangefinder.

An embodiment may include producing, by a rangefinder, a sequence of measurements and selecting from the set a measurement that corresponds to the time of obtaining the image. An embodiment may receive a description of a target plant; identify the target plant in a region; and determine the height of the target plant. An embodiment may automatically select, based on an image, a frequency to be used by a rangefinder. An embodiment may include a camera adapted to obtain images at a sub-millimeteric (submillimetric), high resolution.

An embodiment may apply forward motion compensation to enable capturing images at sub-millimetric resolution. An embodiment may direct a rangefinder and a camera at a reflection surface and direct the reflection surface at a region of interest.

An embodiment may identify a type of a plant in an image based on at least one of: a reflection of a wave received from the plant and an absorption of a wave by the plant. An embodiment may determine a condition of a plant in an image based on at least one of: a reflection of a wave received from the plant and an absorption of a wave by the plant.

An embodiment may calculate statistical data related to a state of a crop in a region. An embodiment may highlight a portion of an image based on a distance measurement. An embodiment may include airborne camera and rangefinder and may continuously synchronize an orientation of the camera with an orientation of the rangefinder. An embodiment may determine the substance of an object in a region based on input from the rangefinder. Other aspects and/or advantages of the present invention are described herein.

### BRIEF DESCRIPTION OF THE DRAWINGS

Non-limiting examples of embodiments of the disclosure are described below with reference to figures attached hereto that are listed following this paragraph. Identical features that appear in more than one figure are generally labeled with a same label in all the figures in which they appear. A label labeling an icon representing a given feature of an embodiment of the disclosure in a figure may be used to reference the given feature. Dimensions of features shown in the figures are chosen for convenience and clarity of presentation and are not necessarily shown to scale. For example, the dimensions of some of the elements may be exaggerated relative to other elements for clarity, or several physical components may be included in one functional block or element. Further, where considered appropriate, reference numerals may be repeated among the figures to indicate corresponding or analogous elements.

The subject matter regarded as the invention is particularly pointed out and distinctly claimed in the concluding portion of the specification. The invention, however, both as to organization and method of operation, together with objects, features and advantages thereof, may best be understood by reference to the following detailed description when read with the accompanied drawings. Embodiments of the invention are illustrated by way of example and not limitation in the figures of the accompanying drawings, in which like reference numerals indicate corresponding, analogous or similar elements, and in which:

FIG. 1 shows a block diagram of a computing device according to illustrative embodiments of the present invention;

FIG. 2A is an overview of a system according to illustrative embodiments of the present invention;

FIG. 2B is an overview of a system according to illustrative embodiments of the present invention;

FIG. 2C shows a top view of a field according to illustrative embodiments of the present invention;

FIG. 2D shows a side view of a field according to illustrative embodiments of the present invention;

FIG. 2E graphically illustrates distance measurements according to illustrative embodiments of the present invention;

FIG. 3 shows a flowchart of a method according to illustrative embodiments of the present invention; and

FIG. 4 illustrates distance measurements and calculations according to illustrative embodiments of the present invention.

### DETAILED DESCRIPTION

In the following detailed description, numerous specific details are set forth in order to provide a thorough understanding of the invention. However, it will be understood by those skilled in the art that the present invention may be practiced without these specific details. In other instances, well-known methods, procedures, and components, modules, units and/or circuits have not been described in detail so as not to obscure the invention. Some features or elements described with respect to one embodiment may be combined with features or elements described with respect to other embodiments. For the sake of clarity, discussion of same or similar features or elements may not be repeated.

Although embodiments of the invention are not limited in this regard, discussions utilizing terms such as, for example, “processing,” “computing,” “calculating,” “determining,” “establishing”, “analyzing”, “checking”, or the like, may refer to operation(s) and/or process(es) of a computer, a computing platform, a computing system, or other electronic computing device, that manipulates and/or transforms data represented as physical (e.g., electronic) quantities within the computer's registers and/or memories into other data similarly represented as physical quantities within the computer's registers and/or memories or other information non-transitory storage medium that may store instructions to perform operations and/or processes. Although embodiments of the invention are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like. The term set when used herein may include one or more items.

Unless explicitly stated, the method embodiments described herein are not constrained to a particular order in time or to a chronological sequence. Additionally, some of the described method elements can occur, or be performed, simultaneously, at the same point in time, or concurrently. Some of the described method elements may be skipped, or they may be repeated, during a sequence of operations of a method.

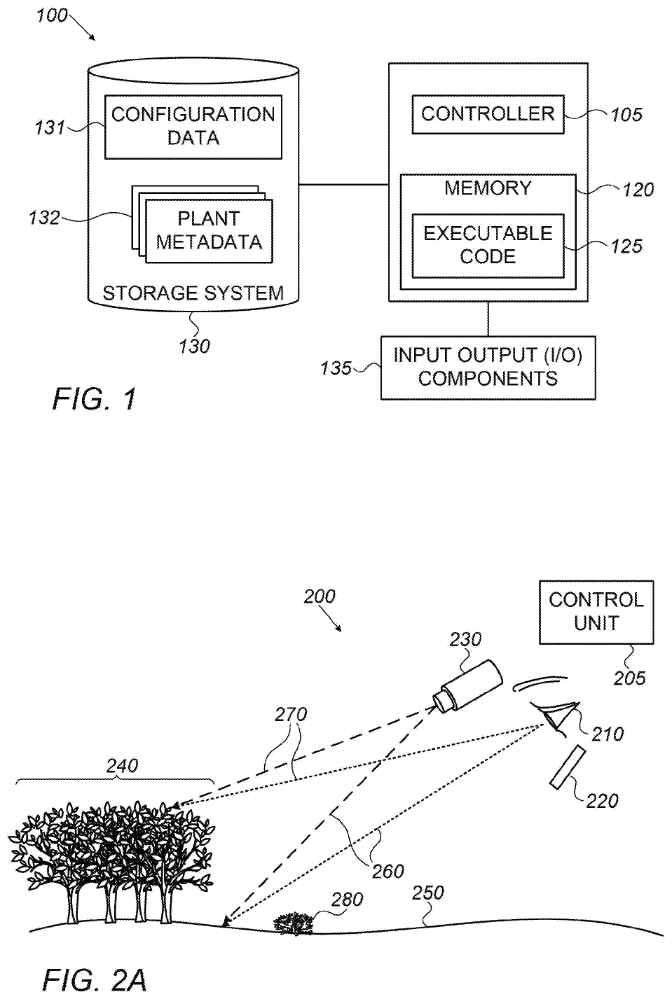

Reference is made to FIG. 1, showing a non-limiting, block diagram of a computing device or system 100 that may be used to determine an attribute of a plant according to some embodiments of the present invention. Computing device 100 may include a controller 105 that may a hardware controller. For example, computer hardware processor or hardware controller 105 may be, or may include, a central processing unit processor (CPU), a chip or any suitable computing or computational device. Computing system 100 may include a memory 120, executable code 125, a storage system 130 and input/output (I/O) components 135. Controller 105 (or one or more controllers or processors, possibly across multiple units or devices) may be configured (e.g., by executing software or code) to carry out methods described herein, and/or to execute or act as the various modules, units, etc., for example by executing software or by using dedicated circuitry. More than one computing devices 100 may be included in, and one or more computing devices 100 may be, or act as the components of a system according to some embodiments of the invention.

Memory 120 may be a hardware memory. For example, memory 120 may be, or may include machine-readable media for storing software e.g., a Random-Access Memory (RAM), a read only memory (ROM), a memory chip, a Flash memory, a volatile and/or non-volatile memory or other suitable memory units or storage units. Memory 120 may be or may include a plurality of, possibly different memory units. Memory 120 may be a computer or processor non-transitory readable medium, or a computer non-transitory storage medium, e.g., a RAM. Some embodiments may include a non-transitory storage medium having stored thereon instructions which when executed cause the processor to carry out methods disclosed herein.

Executable code 125 may be an application, a program, a process, task or script. A program, application or software as referred to herein may be any type of instructions, e.g., firmware, middleware, microcode, hardware description language etc. that, when executed by one or more hardware processors or controllers 105, cause a processing system or device (e.g., system 100) to perform the various functions described herein.

Executable code 125 may be executed by controller 105 possibly under control of an operating system. For example, executable code 125 may be an application that determines an attribute of a plant as further described herein. Although, for the sake of clarity, a single item of executable code 125 is shown in FIG. 1, a system according to some embodiments of the invention may include a plurality of executable code segments similar to executable code 125 that may be loaded into memory 120 and cause controller 105 to carry out methods described herein. For example, units or modules described herein, e.g., a rangefinder and/or a camera may include, or be operatively connected to, a controller 105 and/or memory 120 that includes executable code 125.

Storage system 130 may be or may include, for example, a hard disk drive, a CD-Recordable (CD-R) drive, a Blu-ray disk (BD), a universal serial bus (USB) device or other suitable removable and/or fixed storage unit. As shown, storage system 130 may include configuration data 131 and plant descriptions 132 (collectively referred to hereinafter as descriptions 132 or individually as description 132, merely for simplicity purposes).

Configuration data 131 and plant descriptions 132 may be any suitable digital data structure or construct or computer data objects that enables storing, retrieving and modifying data, information or values. For example, configuration data 131 and plant descriptions 132 may be files, tables or lists in a database in storage system 130, and may include a number of fields that can be set or cleared, a plurality of parameters for which values can be set, a plurality of entries that may be modified and so on.

Data may be loaded from storage system 130 into memory 120 where it may be processed by controller 105. For example, a plant description 132 may be loaded into memory 120 and used for identifying and/or selecting a plant in a region as further described herein.

In some embodiments, some of the components shown in FIG. 1 may be omitted. For example, memory 120 may be a non-volatile memory having the storage capacity of storage system 130. Accordingly, although shown as a separate component, storage system 130 may be embedded or included in system 100, e.g., in memory 120.

I/O components 135 may be, may be used for connecting (e.g., via included ports) or they may include: a mouse; a keyboard; a touch screen or pad or any suitable input device. I/O components may include one or more screens, touchscreens, displays or monitors, speakers and/or any other suitable output devices. Any applicable I/O components may be connected to computing device 100 as shown by I/O components 135, for example, a wired or wireless network interface card (NIC), a universal serial bus (USB) device or an external hard drive may be included in I/O components 135. In some embodiments, I/O components 135 include a camera and a rangefinder as further described.

A system according to some embodiments of the invention may include components such as, but not limited to, a plurality of central processing units (CPU) or any other suitable multi-purpose or specific processors, controllers, microprocessors, microcontrollers, field programmable gate arrays (FPGAs), programmable logic devices (PLDs) or application-specific integrated circuits (ASIC). A system according to some embodiments of the invention may include a plurality of input units, a plurality of output units, a plurality of memory units, and a plurality of storage units. A system may additionally include other suitable hardware components and/or software components. In some embodiments, a system may include or may be, for example, a personal computer, a server computer, a network device, or any other suitable computing device.

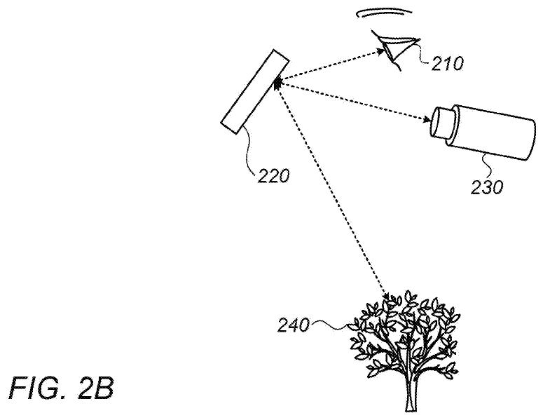

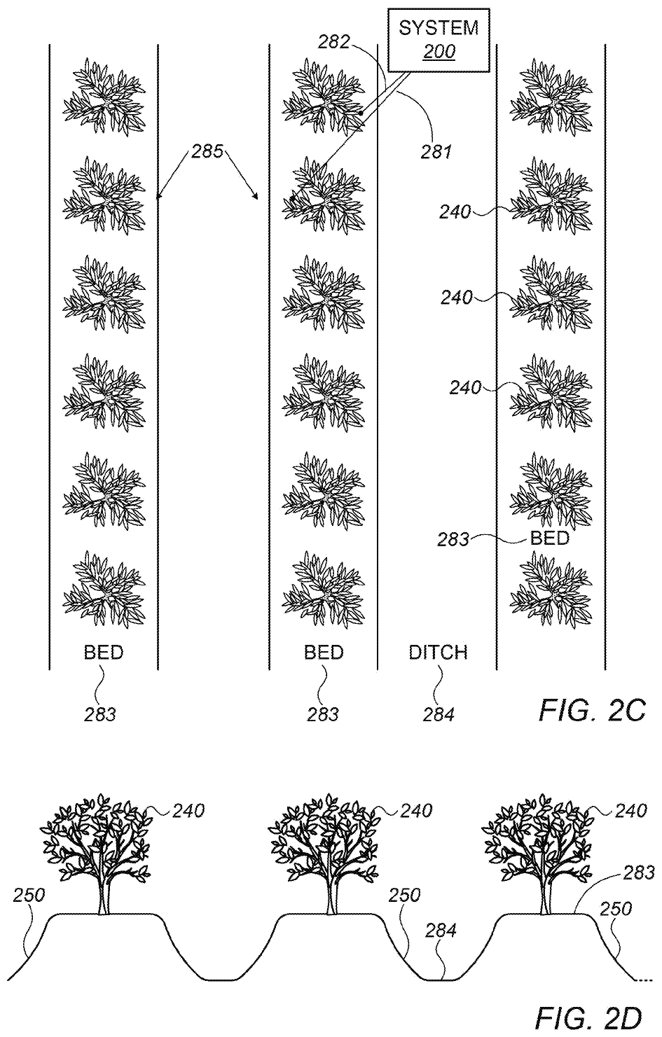

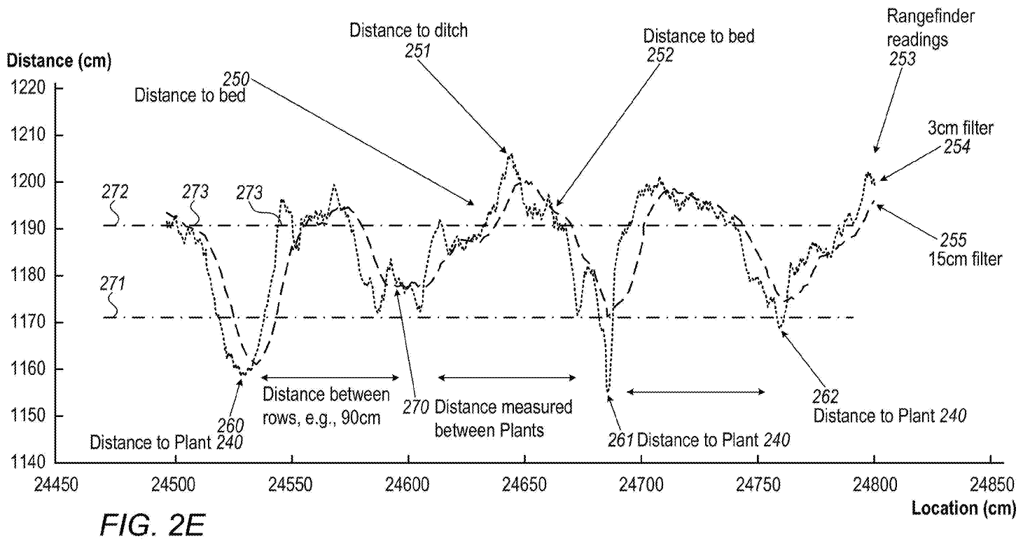

Reference is made to FIG. 2A, an overview of a system 200 and flows according to some embodiments of the present invention. As shown, system 200 may include a control unit 205, a camera 210, a reflection surface 220 and a rangefinder 230. Rangefinder 230 may be any suitable device or system adapted to determine a distance from rangefinder 230 to an object on ground surface 250. Generally, rangefinder 230 may be any system or device that measures a distance from the system or device by (or based on) measuring the round trip time of flight of signals (e.g. a laser beam, electromagnetic radiation) from the system or device to an object and back, for example, rangefinder 230 may be similar to a military rangefinder that determines the distance to a specific target, or it may be similar to a rangefinder included in cameras etc. For example, rangefinder 230 may measure or calculate the distance from any point in system 200 to plants 240 (collectively referred to hereinafter as plants 240 or individually as plant 240, merely for simplicity purposes). Camera 210 may be any suitable image acquisition device, e.g., a digital camera, an infrared sensor and so on. Reflection surface 220 may be a mirror for which an orientation may be dynamically changed, e.g., by control unit 205.

Control unit 205 may include some (or even all) of the components of computing device 100, e.g., a controller 105, memory 120 and executable code 125. Digital and/or analog information or signals may be communicated between control unit 205 and camera 210 and/or rangefinder 230, e.g., using wires or wireless infrastructure. For example, control unit 205 may command camera 210 to capture images and digital representations of images may be sent from camera 210 to control unit 205. Control unit 205 may control operations of camera 210 and of rangefinder 230. Control unit 205 may control an orientation of camera 210 and/or an orientation of reflection surface 220 and/or an orientation of rangefinder 230. For example, by controlling actuators, servomechanism (servos) and the like, control unit 205 may adjust an orientation of any of: camera 210, reflection surface 220 and rangefinder 230.

As described, in some embodiments, acquiring distance measurements by a rangefinder is synchronized with acquiring images by a camera. Generally, a distance measurement as referred to herein may be, or may include a value or number that indicates or quantifies a distance between two points in space. For example, when activated or triggered, rangefinder 230 may provide, e.g., as output, a value (a distance measurement that may be the number of meters, centimeters or millimeters) that describes, quantifies or is, the distance between rangefinder 230 (or another part of system 200) and a point at which rangefinder is directed (or pointed) at.

Synchronizing a distance measurement with an image may include recording the times when a set of distance measurements were made, recording the time an image was acquired and, based on the recorded times, selecting a specific distance measurement, e.g., the distance measurement that was made exactly or substantially exactly when, or closest to (among a number of measurements) when the image was acquired, thus, synchronizing, correlating, associating or linking a distance measurement with an image may be according to, or based on timing or timing data. For example, timing may be, or may include the time an image was taken or the time a distance measurement was made, e.g., based on, or as provided by, an internal clock in system 200.

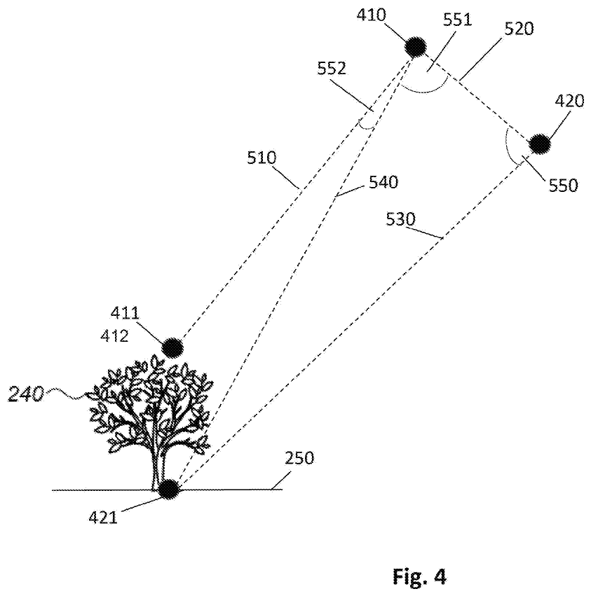

In other cases, synchronization, correlation or association of a distance measurement with an image may include, or achieved by, activating rangefinder 230 and camera 210 simultaneously, concurrently or at the same time, e.g., control unit 205 may time-synchronize (synchronize in time) operation of rangefinder 230 and camera 210 such that a specific distance measurement obtained by rangefinder 230 can be associated, linked, or correlated with a specific image obtained by camera 210. A time recorded as described may be a GMT time with any (fine) resolution or it may be the time of an internal running clock in system 200 that may be set to any resolution, e.g., milliseconds or higher. As described, a distance measurement may be, or may indicate or quantify the distance between a point (e.g., plant 240, a leaf of a plant 240 or a point on ground surface 250) and any point or component in system 200. For example, the distance (position or relative location) of a lens or aperture of camera 210 from (or with respect to) rangefinder 230 may be known (e.g., from a design of system 200 or by simply measuring the distance between, and/or relative locations or orientations of, components in system 200). Accordingly, having measured and/or determined a distance between rangefinder 230 and an object (e.g., plant 240), control unit 205 can readily calculate the distance between the object and camera 210. Accordingly, a distance measurement associated with an image as described may be distance from an object to camera 210. As described with reference to FIG. 4, to determine the height of a plant 240, an embodiment may select (and determine the exact location of) the top of plant 240 (e.g., the location of the point that includes plant 240 with the smallest distance to system 200), the embodiment may further select (and determine the exact location of) a point on ground surface 250 that is substantially directly or vertically under the top of plant 240 and based on the distance between the points the embodiment may determine or calculate the height the plant 240.

In order to determine attributes of an object, e.g., a height of a plant 240, embodiments of the invention may analyze one or more images, identify therein one or more objects (e.g., one or more objects shown in the centers of the respective one or more images) and associate the one or more images with respective one or more distance measurements. For example, rangefinder 230 and camera 210 may be positioned such that rangefinder 230 measures the distance (points to) to a point shown in the center of an image obtained by camera 210. Using any image processing or other technique, control unit 205 (or a server provided with images, distance measurements and timing (e.g., recorded times of obtaining images and distance measurements) or other correlation or association data generated as described) may identify or determine that ground surface 250 is shown in the center of a first image obtained by camera 210 and that the top of plant 240 is shown in the center of a second image obtained by camera 210.

Control unit 205 (or a server) may associate first and second distance measurements with the first and second images as described and thus, in this example, determine the distance from a point or component in/of system 200 to ground surface 250 (e.g., based on an image in which ground surface 250 is identified in the center of the first image as described and based on a distance measurement made when the image was taken) and the distance from a point or component in/of system 200 to the top of plant 240 (e.g., based on an image in which a top leaf of plant 240 is identified in the center of the first image as described and based on a distance measurement made when the image was taken).

A distance measured or calculated as described herein may be to any point in system 200, not necessarily to or from rangefinder 230. For example, a distance from camera 210 to ground surface 250 may be calculated based on a distance measurement from rangefinder 230 to ground surface 250 and further based on a distance between (or relative locations of) camera 210 and rangefinder 230.

Given at least two distances, from a known point or component in/of system 200 to respective at least two objects, e.g., distances of ground surface 250 and top of plant 240 from a known location, point or component of system 200, the distance between ground surface 250 and the top of plant 240 can be calculated, e.g., using triangulation as known in the art. Accordingly, embodiments of the invention provide a number of advantages over current or known systems and methods. For example, unlike known systems and methods that cannot accurately determine for which object a distance was measured (e.g., determine whether a distance measured is to ground surface 250 or to the top of plant 240), embodiments of the invention may associate distance measurements with specific objects. For example, if the distance from system 200 to rock 280 is of interest, an embodiment may obtain a set of images and distance measurements, associate a specific distance measurement with a specific image (e.g., with an image in which rock 280 is exactly at the center of the image) and thus provide the exact distance to rock 280. Embodiments of the invention further improve the relevant technological fields by accurately determining distances to two or more objects as described and, based on the distances, calculate and provide valuable information, e.g., the height of plants 240 may be determine based on distances of ground surface 250 and top of plant 240 from system 200 as described.

For example, ground surface 250 may be identified based on an image captured by camera 210 and, by correlating, associating or linking a distance measurement with ground surface 250, the distance to ground surface 250 may be known. Similarly, a distance measurement for the top of plant 240 may be determined. Based on the distance to ground surface 250, e.g., the distance from system 200 to where ground surface 250 meets plant 240, and the distance to the top of plant 240, the height of plant 240 may be calculated as described.

For example, by controlling their orientation and timing, the point at which camera 210 and rangefinder 230 are directed may be dynamically and/or automatically changed or set by control unit 205 such that at a first time camera 210 and rangefinder 230 are directed as shown by arrows 260 and, at a second time, camera 210 and rangefinder 230 are directed as shown by arrows 270. For example, control unit 205 may continuously adjust the orientation of camera 210 and rangefinder 230 such that they pointing at a direction that is 20° with respect to a vertical line from camera 210 and/or rangefinder 230 to the ground, e.g., when an orientation in space of an aircraft carrying camera 210 and rangefinder 230 changes, control unit 205 may change the orientation of camera 210 and rangefinder 230 such that is kept at a fixed or constant orientation with respect to the vertical line as described.

In some embodiments, determining an attribute of a plant may include obtaining, by a camera, an image of an area or region; producing, by a rangefinder, a measurement of a distance from the rangefinder to a plant in the region; and determining the height of the plant by correlating data in the image with the measurement. The camera and rangefinder may be mobile or moveable and may be translated or moved (e.g., flown) over the region while the image is obtained and the measurement is taken.

For example, system 200 including camera 210 and rangefinder 230 may be airborne and flown over (e.g. translated or flown over) a field of plants 240. The orientations or direction of camera 210 and rangefinder 230 may be known to, and controlled by, control unit 205. As described, control unit 205 may cause camera 210 and rangefinder 230 to point, or be directed to, to the same point in a region. Control unit 205 may control operation camera 210 and of rangefinder 230, for example, control unit 205 may cause camera 210 to take a picture or obtain an image of a field of plants 240 at the same time rangefinder 230 measures the distance thereto. Accordingly, control unit 205 can associate an object in an image with a distance measurement, e.g., based on identifying the object and based on the time the image and measurement were obtained. In some embodiments, a specific distance measurement may be selected from a set of distance measurements based on correlating, associating or linking data in one or more images with a set of distance measurements. For example, a set of distance measurements (and a set of respective images) related to a field of plants 240 (including distances to non-plant objects in the field) may be produced as described, however, depending on the exact orientation or direction of rangefinder 230, some of the distance measurements may represent the distance to ground surface 250, some to rock 280 and some to a plant 240. By correlating images with distance measurements, an embodiment may determine which of the distance measurements are for ground surface 250 and which are for plants 240. For example, assuming that first and second images and distance measurements are obtained at respective first and second times and further assuming that ground surface 250 is shown or included, e.g., in a rectangle of 16×16 pixels in the center of the first image and that plant 240 is similarly shown in the second image, control unit 205 may process the first image, identify that ground surface 250 is shown as described, associate the first image with the first distance measurement and thus determine and/or record the distance to ground surface 250. It is noted that the resolution with which embodiments of the invention can identify objects is only limited by characteristics of components of system 200, e.g., the resolution (e.g., in pixels) of camera 210 and the accuracy of rangefinder 230. Accordingly, using suitable rangefinder 230 and/or camera 210 (e.g., a submillimetric resolution camera) embodiments of the invention may identify, in images (and thus, determine distance to) very small objects, e.g., leaves of plant 240.

For example, control unit 205 may receive a set of distance measurements and a respective set of images, correlate (e.g. link or associate) the images with the distance measurements, e.g., based on the timing of obtaining the images and distance measurements, and determine that a first distance measurement is to ground surface 250 and a second distance measurement is to a plant 240, control unit 205 may then select the second distance measurement for calculating or determining the height of plant 240. By determining that a first distance measurement is to ground surface 250 and a second distance measurement is to plant 240, control unit 205 may be able to calculate (e.g., as described with reference to FIG. 4) the distance between ground surface 250 and plant 240, which is the height of plant 240 with respect to ground surface 250. By identifying a distance measurement to objects other than ground surface 250 (e.g., rock 280), an embodiment may avoid wrongly calculating a height of plants 240.

Based on an association of an object in an image with a distance measure, control unit 205 can determine for which object, element or substance the measurement was obtained or done. Accordingly, control unit 205 can associate a portion of an image with a distance measurement. Any resolution or accuracy level may be used as required. For example, a set of pixels in a digital image provided by camera 210 may be associated with a specific distance measurement. By processing an image provided by camera 210, controller 105 may identify elements, objects or substance in a region, e.g., identify ground surface 250, rock 280 and/or plants 240. By correlating elements, objects or substance in an image with a distance measurement, e.g., based on synchronized and recorded orientation and timing of camera 210 and rangefinder 230 as described, controller 105 may determine whether the measured distance from system 200 is to, for example, ground surface 250, rock 280 or plant 240. Accordingly, controller 105 may accurately calculate the height of plant 240, e.g., by subtracting (or relating) the distance of ground surface 250 from the distance of the top of plant 240.

Correlation of distance measurements and images as described may be done by control unit 205 (e.g., using a controller 105 included in control unit 205) or, in some embodiments, the correlation and/or determination of plants heights or other attributes of plants may be done by a server (not shown), e.g., in offline as referred to in the art. For example, if height or other measurements are to be provided in real-time then control unit 205 include substantial processing power thus enabling it to perform correlation of distance measurements with images as described, in other cases, e.g., if results are not required in real-time or cost of a system is to be kept low, control unit 205 may send measurements and images to a server.

For example, a set of images obtained by camera 210 and a respective set of distance measurements may be provided to a server. A set of images and distance measurements provided to a server may include metadata, for example, metadata for each image and/or measurement may include the time (with an accuracy or resolution of milliseconds or nanoseconds) an image/measurement was taken so that distance measurements can be linked, associated or correlated with images with a very high accuracy. Provided with a set of images and a corresponding set of distance measurements and metadata that may include, for example, the time the measurements and images were taken, the orientation and speed of camera 210 and rangefinder 230 when measurements and images were taken and so on, a server (or control unit 205) may determine, e.g., by associating or relating a specific distance measurements with a specific object or surface in images, that a first distance measurement is of or for an object represented by a certain area or portion of an image, e.g., a rectangle of 8×8 pixels in the center of an image. For example, using image recognition or processing techniques known in the art, e.g., object recognition, pattern recognition and the like, the server may determine the object or point seen or shown in a rectangle of 8×8 pixels (which may be the point hit by a laser beam from rangefinder 230 when the image was taken) in an image is ground surface 250. Similarly, e.g., for a subsequent pair of image/distance measurement, the server may determine a distance to rock 280 was made and, in the same fashion, the server may determine a third distance measurement was of the top of plant 240. Having obtained a distance to ground surface 250 and a distance to the top of plant 240, the server can readily calculate the height of plant 240, e.g., the distance of the top of plant 240 from ground surface 250 (which is the height of plant 240) may be calculated as described with reference to FIG. 4 or using other techniques. Accordingly, embodiments of the invention may associate an object in an image with a distance measurement.

In some embodiments, a height of plant 240 is determined based on at least two distance measurements. For example, using two distance measurements (e.g., from system 200 to ground surface 250 and to top of plant 240) and a known distance between two locations where the respective two distance measurements were made, a location of a point in space (e.g., the location of a point on ground surface 250 or a leaf (or point thereon) at the top of plant 240) may be determined by some embodiment, e.g., using triangulation.

To accurately determine the location of system 200 when a distance measurement is made, some embodiment may measure the horizontal distance between two locations or points where two distance measurements are made. For example, since system 200 may travel (e.g., when airborne) while images and distance measurements are made, an embodiment may take the distance traveled between images and distance measurements into account when calculating locations of points and/or heights as described. For example, using GPS data, IMU data a distance travelled by system 200 may be recorded and thus the location of system 200 may be known when images and/or distance measurements are obtained. As described, e.g., with reference to FIG. 4, locations of system 200 (and images and distance measurements taken therefrom) may be used (taken into account) to identify points such as top of a plant 240 and points on ground surface 250.

In some embodiments, to enhance accuracy, the distance traveled by system 200 is calculated based on the horizontal distance and based on the vertical distance traveled. For example, to provide extended precision, some embodiments may measure the vertical, elevation or altitude difference between the two locations or points in space where two respective images and distance measurements were taken or made. For example, using input from a component in system 200, e.g., data from a global positioning system (GPS), a pressure sensor, a barometer and/or an inertial measurement unit (IMU), the exact altitudes of the two locations may be determined by controller 105. For example, extended precision or resolution may be provided by some embodiments by combining data from a GPS and an IMU. Accordingly, an embodiment can accurately determine two or more distances between system 200 and respective two or more objects (e.g., top of a plant 240 and ground surface 250) and thus calculate and generate valuable information, e.g., the height of plant 240.

In some embodiments, a distance to an object or a section of an object (e.g. a specific patch of ground surface 250, the top or bottom of a plant 240) is determined and recorded when the object, or a section or potion of the object, is in the center or approximate center (e.g. a patch of pixels of a certain dimension such as 8×8) of an image or photo. For example, by setting, adjusting, or controlling orientation of rangefinder 230 and camera 210, rangefinder 230 may be directed at a point that is captured (and appears) at the center of an image captured by camera 210. Accordingly, a distance measurement may be associated, by an embodiment, with a portion or patch of ground surface 250 that appears in a patch or rectangle of 8×8 pixels in an image taken when the distance measurement was made, or a distance measurement may be similarly associated with a leaf of plant 240 that is identified in the patch of pixels.

For example, producing, by rangefinder 230, a measurement of a distance from rangefinder 230 to a plant 240 may be, or may include, producing, by rangefinder 230, a measurement of a distance from rangefinder 230 to a portion of a plant 240, wherein the portion of the plant 240 is imaged substantially in the center of an image that may be associated with the distance measurement as described. In another example, a portion, patch or spot of ground surface 250 in a region may be identified based on the portion being imaged substantially in the center of an image and a distance measurement associated with the image may be recorded as a distance to ground surface 250.

In some embodiments, if an object or surface cannot be identified in a predefined portion of an image (e.g., a predefined set of pixels' locations in an image as described) then the image (and an associated distance measurement) may be ignored or discarded, e.g., since no specific object or surface can be associated with the distance measurement.

For the sake of simplicity, the terms “an object” and “a surface” as used herein may mean, or relate to, a portion or part of an object or surface. For example, a part or patch of ground surface 250 identified in an image may be referred to herein as simply ground surface 250, similarly, identifying any part of a plant 240 (part of an object) may be referred to herein as identifying plant 240 (an object). For example, distance to ground surface 250 as used herein may mean distance to a portion, patch or point on ground surface 250, e.g., the portion, patch or point on ground surface 250 that is captured by a set of pixels in the center of an image. Although correlating the center of an image with a distance measurement is mainly described herein it will be noted that other portions (or sets of pixels) of a digital image may be used, e.g., a distance measurement may be associated with a patch of pixels at the top right or bottom left of an image.

As described, ground surface 250 in a region may be identified based on an image. For example, configuration data 131 may include color or other imaging parameters or values that characterize a terrain in the region, thus controller 105 may identify terrain or ground surface 250 based on attributes in an image. For example, knowing, based on data in configuration data 131, that the color of ground surface is light brown, controller 105 may identify ground surface 250 in images by searching for patches of light brown. In other cases, an image of ground surface 250 may be provided to system 200 (or to a server) that may calculate and/or extract imaging or other characteristics of ground surface 250, e.g., features, frequencies, color histograms and characteristics or attributes of ground surface 250 (as included in a digital image) may be extracted or calculated and used for identifying ground surface 250 in images, e.g., by matching portions of the images with features extracted as described. Accuracy or precision of system 200 may be configurable. For example, a distance measurement may be associated with a small set of pixels that represent a small object shown (or represented) in and image. Accordingly, system 200 may determine the object for which the distance was measured with very high precision, e.g., system 200 may determine that a first distance was measured for rock 280, a second distance was measured for ground surface 250 and a third distance was measured for the top of plant 240.

Generally, a rangefinder is “blind” with respect to the object for which a distance is measured, by associating distance measurements (e.g., from rangefinder 230) with images (e.g., from camera 210), embodiments of the invention solve or eliminate this blindness. For example, based on the times of first and second distance measurements and of respective first and second images, the first distance measurement is associated with ground surface 250 (e.g., since ground surface 250 is in the center of the first image) and the second distance measurement is associated with plant 240 (e.g., since plant 240 is in the center of the second image). Associating, correlating or linking distance measurements with images may include any techniques known in the art, e.g., lists, pointers and the like may be used to associate a digital object that stores a distance measurement with a digital object that stores or includes an image. For example, a list maintained in storage 130 may include, in each row, a first entry that references an object in storage 130 that includes an image, a second entry that includes a references to object in storage 130 that includes a distance measurement, a third object that includes an identification or description of an object (e.g., plant 240 or ground 250 identified at the center of an image as described) and a fourth entry that includes a reading of a clock in system 200. Accordingly, images, distance measurements and the times they were obtained or produced may be associated or linked, e.g., given a specific image, the relevant time or acquisition may be found in the list and the relevant distance measurement may also be found in the list. Of course, other techniques for linking, associating or correlating images, distance measurements and timing or times may be used, e.g., a common database search key, linked lists, pointers and the like.

Generally, the resolution with which images and thus, resolution and accuracy of height, size or other attributes of objects such as plants 240 are only limited by the capacity of system 200. For example, the frequency (number of measurements per second) of rangefinder 230 may be 20,0000 to achieve image resolution of 2 mm, other, more practical resolutions may enable identifying objects of size 3 cm or 15 cm, e.g., as described with reference to FIG. 2E. Accordingly, e.g., to save processing time or memory, system 200 may be configured to operate at any resolution. In some embodiments, raw data including distance measurements obtained at high frequency (e.g., 20,000 measurements per second) may be processed, e.g., filters may be applied based on the type of plants 240. For example, a first filter that averages, or slightly reduces frequency of raw measurements may be applied for crop having small leaves (e.g., of cotton) and a second filter that drastically reduces frequency may be used for other crop (e.g., banana trees. Since system 200 can automatically and/or autonomously identify leaves of plants 240, system 200 may automatically adjust or set the resolution with which it operates thus enabling to save storage space and/or increase performance by reducing computational requirements.

In some embodiments, rangefinder may include a unit for generating and directing electromagnetic waves and ground surface 250 may be identified based on a reflection of an electromagnetic or a radio frequency (RF) wave produced by rangefinder 230 and reflected back from ground surface 250. For example, rangefinder 230 or system 200 may include a radar or other system that emits electromagnetic RF waves and a sensor for sensing a reflection of the waves. Based on characteristics of the reflection absorption and/or reflection of a substance hit by the waves may be determined. Using, for example, information in configuration data 131, controller 105 may determine the type or other attributes or characteristics of an object the reflected a wave as described. Accordingly, objects or elements, e.g., ground surface 250 may be identified using electromagnetic waves or other waves. Generally, objects identified using electromagnetic or other waves as described may be correlated or associated with distance measurements, e.g., by synchronizing a radar with rangefinder 230 as described with respect to synchronizing camera 210 with rangefinder 230.

In some embodiments, a three dimensional (3D) image of a region may be created based on a set of images obtained camera 210 with submillimetric resolution and based on a respective set of measurements obtained by rangefinder 230. For example, using a set of distances to an object (e.g., rock 280) seen in a respective set or sequence of images taken by camera 210, the set of images may be represented in a common coordinate system such that a view of rock 280 from a set of point of views is determined and recorded. Using three or more different views of an object or region, controller 105 may generate an accurate 3D image of the object or region.

As described, images obtained by camera 210 may be in, or of submillimetric resolution, accordingly, embodiments of the invention may produce 3D images with submillimetric resolution. In some embodiments, a 3D image with submillimetric resolution may be produced based on a set of images that were taken while system 200 is moving (e.g., flown over a field) and using forward motion compensation (FMC) as described, e.g., by rotating reflection surface or mirror 220 (and/or camera 210) such that a point, e.g., top of plant 240, is seen, to camera 210 as stationary.

In some embodiments, camera 210 is directed at reflection surface 220. For example, camera 210, via reflection surface 220 (based on light reflected from reflection surface 220), set its focal point at plant 240. As described, reflection surface 220 may be rotated such that the speed of camera 210 (e.g., when carried by a drone) is compensated for such that plant 240 seems or appears, to camera 210, is if it were stationary.

An orientation of reflection surface 220 may be controlled or set, by control unit 205 in sync with, or according to, an orientation of the rangefinder. For example, when rangefinder is directed at rock 280, reflection surface 220 may be tilted or rotated, by control unit 205 such that it reflects an image of rock 280 towards camera 210.

As further described herein, in some embodiments, images and distance measurements may be acquired when system 200 is flying, over a region or field, at considerable speeds. To enable submillimetric resolution images, forward motion compensation (FMC) may be used. In some embodiments, FMC for an airborne system 200 may be achieved by rotating reflection surface 220 (and/or camera 210). Generally, and as further described with respect to FIG. 2B, rotating reflection surface 220 (and/or camera 210) as described may compensate for the forward motion of system 200 (e.g., the forward motion of the drone carrying system 200) such that a point (or patch) on round surface 250, a leaf of a plant 240 or any other object, reflected from reflection surface 220 towards camera 210 seems, to camera 210, stationary, at least during a short time interval. In some cases, rotating reflection surface 220 (and/or camera 210) as described may compensate for a change of direction (and not just for the forward motion) of a drone carrying system 200 such that a point or object on ground surface 250 seems stationary or completely still to camera 210 even when the direction with which system 200 moves changes.

Generally, rotating reflection surface 220 may compensate for any one of the forward motion of system 200, a change of flight direction and/or an orientation of system 200 with respect to ground surface 250. For example, a rotation of reflection surface 220 may provide FMC while, at the same time, the orientation of reflection surface 220 is set so that a vertical view of plants 240 is provided to camera 210, and, in addition, the orientation of reflection surface 220 is set such that a change of direction of flight is compensated for.

In some embodiments, reflection surface 220 may be moved or rotated during the process of acquisition of image data. Moving of reflection surface 220 may be executed when the image data is actually gathered (e.g. when a charge-coupled device (CCD) in camera 210 is collecting light arriving from an agricultural area including plants 240), but may also be executed in other parts of the process of image data acquisition (e.g. during a focusing process which precedes the light collection). Generally, motion compensation as described may reduce the relative speed between the imaged object (e.g., plant 240) and camera 210 to substantially zero, or simply reduce it enough so that the effects of the relative motion between the two on the quality of an image are lower than a predefined threshold, accordingly, embodiments of the invention may acquire images at (or with) submillimetric resolution.

In some embodiments, rangefinder 230 produces a sequence of measurements and controller 105 (e.g., included in control unit 205) may select, from the sequence, a measurement that corresponds to the time of obtaining the image. For example, control unit 205 may cause rangefinder 230 to obtain 20,000 distance measurements during a time interval of one second (20 K/sec) and may further cause camera 210 to capture in image during the time interval. Any logic may be used for associating a distance measurement with an image, for example, the last distance measurement obtained before an image was obtained and the first distance measurement obtained right after the image may be associated with the image or may be taken into account.

A set of distance measurements may be associated with a single image. For example, in addition to selecting one distance measurement (the one made exactly when an image was captured), 100 distance measurements made right before the image was taken and/or 100 distance measurements made right after the image was taken may be used. For example, since the velocity V of a drone carrying system 200 is known, a distance measurement made T milliseconds before an image was taken can be associated with an object in the image, e.g., an object that is shown at a distance S from the center of the image where S=T×V. Accordingly, an embodiment may require a relatively small number of images in order to determine and provide to a user valuable information such as height of plants in a filed.

In some embodiments, control unit 205 may adjust or set the rate by which rangefinder 230 obtains measurements (and the rate by which camera 210 obtains images) based on the velocity with which rangefinder 230 and/or camera 210 are translated over a region. For example, control unit 205 may cause rangefinder 230 to obtain 7,000 measurements per second when a drone or an aircraft carrying rangefinder 230 and camera 210 (thus translating rangefinder 230 and camera 210 over the region) flies at the speed of 3 kilometer per hour (kph) and, if the aircraft accelerates its speed to 6 kph, control unit 205 may automatically increase the rate with which rangefinder 230 obtains measurements to 14,000 measurements per second. Similarly, the rate with which camera 210 obtains images may be adjusted based on the speed of the vehicle moving camera 210 over a region.

Controller 205 may record the exact time an image was captured as well as the times measurements are obtained, accordingly, a specific one measurement in the sequence of measurements taken as described may be associated with an image.

In some embodiments, the height or other attributes of a specific plant may be identified even if a region includes more than one type of plants. In some embodiments, a description of a target plant may be received and used to identify the target plant in a region, height or other attributes of the target plant may be determined as described. For example, a plant metadata 132 object may describe corn, e.g., in the form of color, absorption of specific laser or other wave length and so on. Based on an image produced by camera 210 as described and based on information in a plant metadata or description 132 object, controller 105 may identify corn plants in plants 240 and may measure the height of corn plants as described. For example, using a description of corn in plant metadata 132, controller 105 may find corn plants in an image and may, e.g., based on recorded timing and orientation of camera 210 and rangefinder 230, identify distance measurements related to the corn plants and not ones related to cabbage, e.g., in an adjacent field. For example, using image processing techniques as described, if control unit 205 or a server identifies plants in images are not corn plants (e.g., they are weeds with a color that is different from a known, preconfigured color of corn plants) then an embodiment may ignore the images and their respective distance measurements. Accordingly, an embodiment may be configured to measure height or other attributes of selected or specific plant types or objects in a region and disregard or ignore other plants or objects in the region. It will be noted that based on plant metadata 132 any selection of plants may be made. For example, based on information that describes the colors of corn plants at different times, states or conditions, an embodiment may automatically select to determine height or other attributes of plants according to their state or condition. For example, based on plant metadata 132, system 200 may selectively measure the height only for corn plants that sprouted a week ago, a month ago and so on, or it may measure the height only of corn plants that begun to flower. Of course, system 200 may selectively measure the height only of corn plants, wheat or other plants in a field or region.

In some embodiments, a frequency used by rangefinder 230 may be automatically and/or dynamically selected based on an image captured by camera 210. For example, configuration data 131 may indicate an optimal laser frequency for green color and another optimal frequency for brown. Based on colors seen in an image, controller 105 may set the frequency used by rangefinder 230, accordingly, a frequency used by rangefinder 230 may be dynamically and automatically selected, based on an image.

In some embodiments, camera 210 may be a camera capable of obtaining images at sub-millimeteric resolution. Accordingly, precision of measurements produced as described herein may be practically unlimited. For example, height of a plant 240 may be determined with sub-millimeter accuracy by correlating a distance measurement produced by rangefinder 230 with a small set of pixels in an image produced by camera 210, e.g., a distance measurement may be associated with an area such as a rectangle of 16×16 pixels in an image having sub-millimeter resolution.

In some embodiments, e.g., to enable capturing images at sub-millimetric resolution, forward motion compensation may be used or applied. For example, as described, rather than being directed or aimed at plants 240, camera 210 may be directed or aimed at reflection surface 220 that may in turn be directed or aimed at plants 240. To include or apply motion compensation, control unit 205 may move, orient or rotate reflection surface 220 such that while camera 210 is moving over a region (e.g., when airborne), a specific point in a region is reflected by reflection surface 220 towards camera 210.

Reference is additionally made to FIG. 2B showing components of system 200 and flows according to some embodiments of the present invention. As shown, rather than pointing, or being directed at, plant 240, camera 210 and rangefinder 230 may point, or be directed at, reflection surface (or mirror) 220 which may in turn be orientated such that a wave emitted by rangefinder 230 hits plant 240 and such that light emitted or reflected by plant 240 hits (is reflected from) mirror 200 and reaches camera 210 and rangefinder 230.

In some embodiments, control unit 205 may use data from devices as described, e.g., GPS, IMU and/or any data (e.g., speed) of an aircraft carrying camera 210 and, based on such data, control unit 205 may, e.g., for a short time interval, rotate (or otherwise change orientation of) reflection surface 220 such that, during the short time interval, a specific point (e.g., a leaf of plant 240) is reflected towards camera 210 and seems, to camera 210, fixed in place during the short time interval, thus enabling camera 210 to obtain an image of the point with submillimetric resolution. For example, to compensate for a forward motion of an aircraft carrying camera 210 and reflection surface 220, control unit 205 may rotate reflection surface 220 backwards, thus compensating for the forward motion and keeping reflection surface 220 directed at a fixed point on a surface. Otherwise described, the motion compensation causes a point or object (e.g., a plant 240) to seem stationary or semi-stationary to camera 210 thus enabling camera 210 to capture an image of the point or object with sub-millimeter resolution.

The forward motion compensation enables embodiments to capture images at sub-millimetric resolution. For example, in cases where camera 210 is flown over plants 240 at high speed (e.g., 10 kph), without forward motion compensation, it may be impossible to obtain sub-millimetric resolution images since the speed causes images to be blurred, by compensating for motion as described, embodiments of the invention enable very high or sub-millimetric resolution images to be obtained even in cases where camera 210 is flown at very high speed over a region. Sub-millimetric resolution images (and high accuracy of rangefinder 230) enable embodiments of the invention to provide measurements of plants 240 with extended precision, e.g., separate or specific leafs of a plant 240 can each be identified (and clearly seen in images produced by camera 210) and their respective height can be determined, thus, the height of a plant 240 can be determined with sub-millimetric accuracy.

In some embodiments, both camera 210 and rangefinder 230 are directed at reflection surface 220 (e.g., as shown in FIG. 2B) and reflection surface 220 is directed or aimed at plants 240 such that it reflects an image of plants 240 towards camera 210 and rangefinder 230. Such arrangement or configuration ensures that camera 210 and rangefinder 230 are directed at the exact same spot or location in a region. For example, reflection surface 220 may be adapted (e.g., using gold plating) to reflect a laser beam from rangefinder 230 towards plants 240, receive a reflection of the beam from plants 240 and forward the reflection towards rangefinder 230, accordingly, both camera 210 and rangefinder 230 may “see” plants 240 via reflection surface 220. Of course, an arrangement whereby both camera 210 and rangefinder 230 are directed at reflection surface 220 can further include motion compensation as described.

Any number of rangefinders 230 may be included in system 200, e.g., a first rangefinder 230 may be directed at reflection surface 220 and a second rangefinder 230 may be directed, or pointed at plants 240 or ground surface 250, for example, the second rangefinder 230 may be directed along a vertical axis from system 200 to ground surface 250. Control unit 205 may select which of a set of rangefinders 230 to use, e.g., the first rangefinder 230 may be used when system 200 is not directly above plants 240 and the second rangefinder 230 may be used when system 200 is directly above plants 240.

Reference is made to FIG. 2C showing a top view of a field where plants 240 are grown. As shown, rows 285 of plants 240 may be on, or may include, beds 283 that may be separated by, and higher than, ditches (e.g., tractor tracks) 284. As shown, a first distance measurement 282 (which may or may not be associated with a first image) may be to a top leaf of plant 240 but a second distance measurement 281 (which may or may not be associated with a second image) may be of lower leaves or even ground surface 250, e.g., when a laser beam from rangefinder 230 passes between leaves of plant 240 and hits ground surface 250. Accordingly, some filtering, averaging or other processing of distance measurements as provided by rangefinder 230 may be needed and performed by embodiments of the invention as further described herein.

Reference is additionally made to FIG. 2D showing a side view of the field shown in FIG. 2C. Since, in some embodiments, the distance between rows of plants 240 is set by the seed drill (a device that sows the seeds with great precision with respect to distances between rows), by identifying at least one location of plant 240 (or a row 285), the locations of other plants 240 or rows 285 may be determined as further described.

Reference is made to FIG. 2E which graphically illustrates distance measurements (rangefinder readings 253) provided by rangefinder 230 and calculated data created based on the distance measurements. As shown, a curve 253 may represent distance measurements taken at 20 K/sec by rangefinder 230, curve 254 may represent a filter that reduces the resolution to 3 cm (e.g., enabling identifying leaves) and curve 255 further reduces the resolution to 15 cm (e.g., for cases where leaves are larger than 10 cm). For example, curve 255 may be related to (or used for identifying) foliage comprised of a number of leaves, e.g., clusters of leaves that are approximately 15 centimeters in size and curve 254 may be related to (or used for identifying) objects (e.g., leaves) that are the size of approximately 3 centimeters.

The three distances to plant 240 260, 261 and 262 may be distances to plants different rows 283, distances to bed 250 and 252 may represent distance from system 200 to beds 283 and distance to ditch 251 may represent distance from system 200 to ditch 284. As shown, by distance 270, if a wave or beam emitted by rangefinder 230 may pass between plants 240 (e.g., the wave or beam hits foliage between plants and not a top of a plant), or the laser beam passes between the top leaves of a plant 240 (and bounces back from lower leaves of plant 240) then the distance measured may be larger than that of a distance to a top of a plant 240. As described, by averaging distances measured and by further using thresholds, cases where the distance measured is not to a top of a plant may be identified and ignored. For example, using threshold 271, the distance measured as shown by 270 may be automatically ignored since it may be the distance to foliage between plants 240 and not the distance to a top of a plant 240.

In some embodiments, a threshold may be used in order to filter out invalid distance measurements. For example, a threshold represented by dashed line 271 may be used, e.g., to determine that distance measurement 270 is not of a top of a plant 240 since it is above threshold 271. Accordingly, embodiments may verify distance measurements are indeed related to plants 240 (e.g., by identifying they are below threshold 271) and may further ignore distance measurements that are above threshold 271. A threshold may be dynamically and/or automatically set, e.g., based on averaging distance measurements or otherwise. A threshold for validating or verifying a distance measurements are to ground surface 250 may be similarly set and used.

Identifying the bed where plants 240 are planted or sowed may be of particular importance since a bed 283, e.g., identified as shown by distances to bed 250 and 251, may be considered as the reference based on, or wherefrom, a height of plants 240 is measured. For example, an embodiment may generate or define a line or threshold illustrated by dashed line 272 such that the crossing of dashed line 272 and one or more of curves 254 or 255 indicates the exact height of the beds. The height of plants 240 may be calculated by subtracting the distance of a bed 283 surface from the distance of the top of a plant 240, accordingly, by automatically identifying plant beds 283, height of plants 240 may be determined or calculated. For example, points 273 where dashed line 272 crosses curve 254 may be identified as indicating a bed 283 and thus the distance to bed 283 may be determined.

In addition to using a threshold for verifying a distance measurement is to a plant 240 (or ground surface 250) and embodiment may use information related to the planting or sowing of plants 240. For example, a farmer may provide control unit 205 or a server with the space or distance between rows planted or sowed by a seed drill used for sowing or planting plants 240, e.g., the space or distance between rows 285 is 90 centimeters as shown by FIG. 2E. Therefore, having determined that distance measurement 260 is indeed to a top of a plant 240 (e.g., by identifying a leaf in the center of an image taken when distance measurement 260 was made), control unit 205 or a server may know exactly where an adjacent or next row of plants is expected to be. Accordingly, an embodiment may verify distance measurements are indeed to a specific object or point (e.g., top of a plant 240 or ground surface 250) based on information related to planting or sowing plants 240.

For example, if the distance between rows 285 is known to be 90 cm then, if control unit 205 identifies a distance measurement that may be of a plant 240 but is with a distance of only 45 cm from another distance measurement of a plant 240 then control unit 205 may determine that at least one of the distance measurements is not of a plant 240.

In another case, problems may be identified. For example, if control unit 205 identifies that, with respect to where a plant 240 or row 285 are expected, distance measurements indicate no plants 240 or row 285 exist, or that distance measurements are above a threshold (e.g., threshold 271 or another threshold) then control unit 205 may inform or alert a user, e.g., by presenting a notification on a monitor of a computer or sending a message. For example, due a fault in an irrigation system, plants 240 in one of rows 285 may be smaller than other plants in a field, identifying the row 285 as described, control unit 205 may alert a farmer pointing to the location of the relevant row 285 or otherwise identifying the location of a problem.

For example, an embodiment may identify a problem with the row measured by distance measurement 270, e.g., since distance between rows 285 related to distance measurements 260 and 261 is identified as 180 cm apart thus, an additional row is expected between these two rows. If more than a threshold number of distance measurements to a line or location of an expected row, e.g., taken in a set of passes crossing, or perpendicular to, the direction of the row indicate that no row exists at the location then an embodiment may alert a user as described. Accordingly, by automatically identifying plants 240 and rows 285, embodiments may identify various problems.

In some embodiments, control unit 205 may identify the direction of rows 285 in a field and may be navigate a drone or aircraft carrying system 200 such that it passes over the filed in, or along a direction that is perpendicular to rows 285. Efficiency and accuracy may be increased by automatically causing system 200 to pass across, and not along, rows 285 when images and distance measurements are obtained. For example, if system 200 travels along a row 285 then most (or even all) of the images and distance measurements obtained may be of plants 240 and not (or never) of ground surface 250 thus, for example, determining a height of a plant 240 based on the distance of its top from ground surface 250 may be impossible.

In some embodiments, camera identifying a type of a plant in an image may be based on at least one of: a reflection of a wave from the plant and an absorption of a wave by the plant. For example, based on comparing the frequency, amplitude or other characteristics of a reflection of a laser bean directed at plants 240 and based on information in plant metadata 132 or configuration data 131, controller 105 may determine the type of plant 240. For example, amplitude and color absorbed and/or reflected by corn and by wheat may be when hit by a laser beam may be recorded in plant metadata 132 or configuration data 131, accordingly, based on a reflection of a laser from plants 240, controller 105 may identify or determine whether plants 240 are corn or wheat.

In some embodiments, a condition of a plant may be determined based on an image and/or based on a reflection/absorption of a wave. For example, by comparing amplitude, color or frequency of a wave emitted by rangefinder 230 and reflected by plants 240 to data in plant metadata 132 or configuration data 131, controller 105 may determine a condition of plants 240, e.g., plants 240 need more water, are infected by a disease or suffer from excessive irrigation. For example, plant metadata 132 and/or configuration data 131 may include sets of laser reflection values that correspond to sets of conditions, e.g., different reflection values or characteristics may be empirically or otherwise determined for respective different conditions of plants, accordingly, a condition of a plant may be determined based on a reflection of a wave as described.

In some embodiments, substance of an object in a region may be identified or determined based on correlating input from rangefinder 230 with an image acquired by camera 210. For example, from above, a white rock and a white blanket may seem the same, however, by having identified a white element based on an image provided by camera 210, controller 105 may analyze a reflection of light shot by rangefinder towards the white element and determine that the element is a soft material such as blanket. Accordingly, a combination of image and wave reflection, which are controlled such that they capture relevant input from the same spot or element enables embodiments of the invention to accurately identify elements or objects in a region.

Element identification may further be automated by providing system 200 with a description of an element. For example, an image of an element which a user wants to find in a region and/or reflection properties of the element may be provided. Controller 105 may search, in real-time, for the element in images of the region obtained as described, and, if a match is found, controller 105 may direct or orient rangefinder 230 such that reflection from the element is obtained and used for further or additional verification that the element found is indeed the element of interest. As described, a frequency of a light used by rangefinder 230 may be automatically selected based on characteristics of the plant, object or item of interest.

In some embodiments, statistical data may be calculated for a region or field. For example, statistical data related to a state of a crop in a field or region may be created, e.g., based on attributes of plants 240 in a field or region. For example, based on images acquired by camera 210, an average fruit size, an estimated crop amount and the like may be calculated.

In some embodiments, a portion of a region or field may be highlighted based on a measurement of height and based on an image. For example, a region may include a corn field and a citrus grove, in case a user indicates corn is of interest (e.g., by including a description of corn in plant metadata 132) an embodiment may identify corn as described and may draw a line around corn plants in the region or field.

In some embodiments, an orientation of camera 210 and of rangefinder 230 may be continuously, automatically and/or dynamically synchronized and/or adjusted, e.g., such that camera 210 and rangefinder 230 point, or are directed at, the same point in a region. For example, camera 210 and rangefinder 230 may be airborne and, therefor, in order to point to plants 240, their orientation needs to be adjusted as the aircraft carrying them flies over the region. As described, an orientation or direction of camera 210 and rangefinder 230 may be adjusted such that they are both directed at the same point in space.

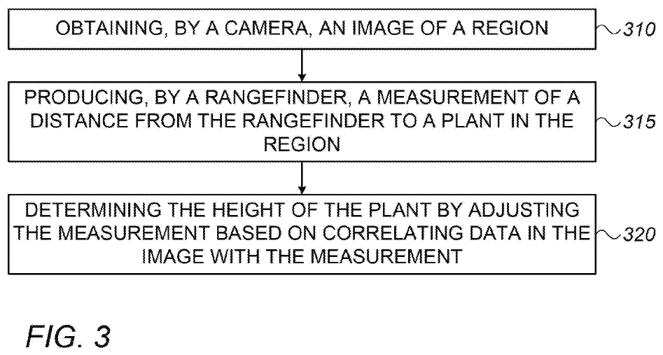

Reference is made to FIG. 3, a flowchart of a method according to illustrative embodiments of the present invention. As shown by block 310, an image of a region may be obtained by a camera, e.g., camera 210 may obtain an image of a region as described. As shown by block 315, a measurement of a distance from a plant to a rangefinder may be produced by the rangefinder. For example, rangefinder 230 may produce a measurement of a distance from a plant 240 to rangefinder 230. As shown by block 320 a height of a plant may be determined by adjusting or selecting a distance measurement based on correlating data in the image with a measurement. For example and as described, by correlating data in an image with a measurement, controller 105 in control unit 205 may determine whether a measured distance is to a plant 240, ground surface 250 or rock 280.

Reference is made to FIG. 4, illustrating distance measurements and calculations according to illustrative embodiments of the present invention. Assuming that at some time T₀ (e.g., 10:00:00) system 200 is at point 410 in space where point 410 may be known, that is, located, defined or characterized, e.g., using GPS data, IMU data and so on. A distance measurement 510 may be made when system 200 is at point 410 thus location of point 411 may likewise be known and recorded. For example, point 411 may be on, or a portion of, leaf 412 which may appear in the center of an image taken by camera 210 and may be identified as a top leaf (e.g., since no other leaf covers it), accordingly, measured (and recorded) distance 510 may be to the top portion of plant 240.

Next, system 200 may travel, in a known or monitored and recorded direction, a distance 520 to point 420 (which may similarly be known, defined and/or characterized and recorded by control unit 205). A distance measurement 530 may be taken when system 200 is at point 420, e.g., at time T₁ after T₀ (e.g., 10:00:01). For example, point 421 may be a patch of ground surface 250 identified as described, e.g., in the center of an image. Angles 550 and 551 may be determined (based on location of points 410, 420 and 421). Accordingly, since two sides or vertices of a triangle and the angle between them fully define a triangle, dimensions of the triangle formed by vertices 410, 420 and 421 may be calculated, thus distance 540 may be determined.

Angle 552 may be determined, e.g., by subtracting the (recorded) angle between vertices 540 and 520 from the angle between vertices 520 and 510, thus the triangle formed by vertices 410,411 and 421 may be fully and unambiguously defined and the distance between points 421 and 411, which is the height of plant 240, may be determined.

It is noted that while distance between points 421 and 411 may be calculated by embodiments of the invention for any two points as described, to determine a height of plants 240, embodiments of the invention may select points 411 and 421 such that they correspond to, or represent a top of a plant 240 and ground surface 250 at a point that plant 240 meets the ground. By correlating or associating distance measurements with images as described, points as described with reference to FIG. 4 may be selected such that they represent, or are related to, top of plants 240 and ground surface 250. Accordingly, introducing correlation of images and distance measurements, embodiments of the invention can determine to what a distance is measured, e.g., to ground surface 250 or to the top of a plant 240. Otherwise described, unlike known systems and methods, distance measurements in some embodiments of the present invention are not blind with respect to a distant object, rather, embodiments of the invention may associate distance measurements with objects or elements, e.g., a top of a plant 240, a rock 280 or a ground surface 250.

In some embodiments, e.g., in cases where plants 240 are relatively small, many of the images and distance measurements may be of, for or related to ground surface 250. Accordingly, an embodiment may estimate or identify ground surface 250 for any point in a field. For example, a set of points 421 on ground surface 250, e.g., around plant 240, may be used to calculate or determine, e.g., using extrapolation techniques, a point on ground surface 250 that is exactly (or vertically) under point 411.

For example, a large set of distance measurements may be obtained as described during a time when a smaller set of images are captured as described, next, an image in which a top of plant 240 is shown (e.g., in a predefined rectangle in the center) is identified and selected, and using its capture time, the relevant distance measurement is selected thus points such as those shown in FIG. 4 may be chosen such that they are a top of a plant and a point on the ground and the height of the plant may be calculated as described.

In the description and claims of the present application, each of the verbs, “comprise” “include” and “have”, and conjugates thereof, are used to indicate that the object or objects of the verb are not necessarily a complete listing of components, elements or parts of the subject or subjects of the verb. Unless otherwise stated, adjectives such as “substantially” and “about” modifying a condition or relationship characteristic of a feature or features of an embodiment of the disclosure, are understood to mean that the condition or characteristic is defined to within tolerances that are acceptable for operation of an embodiment as described. In addition, the word “or” is considered to be the inclusive “or” rather than the exclusive or, and indicates at least one of, or any combination of items it conjoins.

Descriptions of embodiments of the invention in the present application are provided by way of example and are not intended to limit the scope of the invention. The described embodiments comprise different features, not all of which are required in all embodiments. Some embodiments utilize only some of the features or possible combinations of the features. Variations of embodiments of the invention that are described, and embodiments comprising different combinations of features noted in the described embodiments, will occur to a person having ordinary skill in the art. The scope of the invention is limited only by the claims.

While certain features of the invention have been illustrated and described herein, many modifications, substitutions, changes, and equivalents may occur to those skilled in the art. It is, therefore, to be understood that the appended claims are intended to cover all such modifications and changes as fall within the true spirit of the invention.

Various embodiments have been presented. Each of these embodiments may of course include features from other embodiments presented, and embodiments not specifically described may include various features described herein.

1. A method of determining an attribute of a plant, the method comprising:
directing at least one of a camera and a range finder at a reflection surface and directing the reflection surface at a region;
obtaining, by the camera, an image of the region;
producing, by the rangefinder, a measurement of a distance from a rangefinder to a plant in the region; and
determining the height of the plant by correlating data in the image with the measurement, the measurement comprising:
a first distance measurement from the rangefinder to the plant designating the top of the plant and a second distance measurement from the rangefinder to the plant designating the bed of the plant, and
setting a distance threshold to filter out invalid distance measurements of distance from the rangefinder to the plant;
wherein the camera and rangefinder are mobile and are translated over the region.

2. The method of claim 1, wherein ground surface in the region is identified based on the image.

3. The method of claim 1, wherein ground surface in the region is identified based on a reflection of an electromagnetic wave.

4. The method of claim 1, comprising, creating a three dimensional (3D) image of the region based on:
a set of images obtained by the camera with submillimetric resolution; and
a respective set of measurements.

5. (canceled)

6. The method of claim 1, comprising, producing, by the rangefinder, a sequence of measurements and selecting from the set a measurement that corresponds to the time of obtaining the image.

7. The method of claim 1, wherein the camera is adapted to obtain the image at a submillimetric high resolution.

8. The method of claim 1, comprising applying forward motion compensation to enable capturing images at sub-millimetric resolution.

9. A method of determining a height of a plant, the method comprising:
directing at least one of a camera and a range finder at a reflection surface and directing the reflection surface at a region;
obtaining a set of images of the region;
producing, by a rangefinder, a set of distance measurements from the rangefinder to the plant;
selecting, based on correlating data in the images with the distance measurements from the rangefinder to the plant, a first distance measurement from the rangefinder to the plant related to a plant in the region and a second distance measurement from the rangefinder to the plant related to a ground surface in the region, and setting a distance threshold to filter out invalid distance measurements of distance from the rangefinder to the plant; and
using the first and second distance measurements to calculate a height of the plant.

10. A system comprising:
a camera;
a rangefinder;
a memory; and
a controller adapted to:
direct at least one of a camera and a range finder at a reflection surface and directing the reflection surface at a region;
obtain, from the camera, an image of the region;
obtain, from the rangefinder, a measurement of a distance to a plant in the region; and
determine the height of the plant by correlating data in the image with the measurement of distance to the plant, the measurement comprising:
a first distance measurement of distance to the plant designating the top of the plant and a second distance measurement of distance to the plant designating the bed of the plant, and
setting a distance threshold to filter out invalid distance measurements of distance to the plant;
wherein the camera and rangefinder are mobile and are translated over the region.

11. The system of claim 10, wherein ground surface in the region is identified based on the image.

12. The system of claim 10, wherein the controller is further adapted to create a three dimensional (3D) image of the region based on:
a set of images obtained by the camera with submillimetric resolution; and
a respective set of measurements.

13. (canceled)

14. The system of claim 10, wherein the controller is further adapted to receive, from the rangefinder, a sequence of distance measurements and select from the set a measurement that corresponds to the time of obtaining the image.

15. The system of claim 10, wherein the controller is further adapted to automatically select, based on the image, a frequency used by the rangefinder.

16. The system of claim 10, wherein the camera is adapted to obtain the image at a submillimetric high resolution.

17. The system of claim 13, wherein the reflection surface is adapted to apply forward motion compensation to enable capturing images at submillimetric resolution.

18. The system of claim 10, wherein the camera and the rangefinder are airborne and wherein the controller is further adapted to continuously synchronize an orientation of the camera with an orientation of the rangefinder.

19. The system of claim 10, wherein controller is further adapted to determine the substance of an object in the region based on input from the rangefinder.

20. The system of claim 10, wherein controller is further adapted to determine at least one of:
a condition of the plant and a type of the plant.
